(19) United States
(12) Patent Application Publication
(10) Pub. No.: US 2011/0263004 A1
(43) Pub. Date: Oct. 27, 2011

(54) Method of treating biomass

(76) Inventors: Hannu Ilvesniemi, Vantaa (FI); Bjarne Holmborn, Abo (FI); Veikko Kitunen, Vantaa (FI); Kaisu Leppänen, Vantaa (FI); Andrey Pranovich, abo (FI); Peter Spetz, Vantaa (FI); Lari Vähäsalo, Abo (FI)

(21) Appl. No.: 12/935,613

(22) PCT Filed: Apr. 2, 2009
(86) PCT No.: PCT/FI2009/050251

§ 371 Date: Mar. 21, 2011

(30) Foreign Application Priority Data
Apr. 2, 2008 (FI) 20085275

(51) Int. Cl. C08B 37/00; D21F 11/00; C10L 5/44

(52) U.S. Cl. 435/274; 44/589; 536/123.1; 162/202

(57) ABSTRACT

Method of treating a biomass containing a fibrous structure and polysaccharides. According to the method the biomass is subjected to extractive treatment at which it is heated in aqueous phase at an absolute pressure of over 0.6 MPa and a temperature of at least 160° C. for separating polysaccharides from the mass. According to the invention, the pH of the biomass which is subjected to the extractive treatment is not actively lowered during the extraction and after the treatment the pressure is controllably reduced so as not to decompose the fibrous structure of the biomass. The polysaccharides separated from the mass are recovered as a first fraction, the fibrous structure of the biomass as a second fraction and at least one of the fractions is subjected to further processing. By means of the invention it is possible to isolate from the starting materials valuable compounds and groups of compounds by a method suitable for use on an industrial scale.

The present invention concerns a method according to the preamble of claim 1 for treating biomass.

According to such a method, compounds contained in the biomass, such as sugars and derivatives thereof and the corresponding polysaccharides, are separated from the biomass by extraction.

It is well-known that trees and other plants contain in addition to lignin and cellulose also about 25% by weight of hemicellulose which primarily is composed of hexoses and pentoses. For coniferous trees the proportion of hexoses is larger whereas for deciduous trees and for grass plants and straw the proportion of pentoses is greater. Peat formed by the dead parts of Bryophytes, such as peat moss, exhibit a hexose-to-pentose ratio which lies between those of the above mentioned two species of plants. Hemicelluloses isolated from wood material are valuable compounds in fiber and paper processes and in fibrous and paper products. Hemicelluloses, and in particular the galactoglucomannans of coniferous trees, are potentially valuable raw-materials for the chemical and the food industry. Xylose isolated from deciduous trees is the raw-material for xylitol. Hexoses obtained by hydrolysis of hemicellulose of coniferous trees to form monomers can be used for the production of ethanol utilizing normal yeast strains. Also annual and perennial plants and parts thereof, such as canary reed grass and the straw of corn, as well as bog plants and the peat which is formed by their dead parts contain valuable polysaccharides which form an interesting raw-material for the chemical industry, the pharmaceutical industry and, for example, for the production of ethanol.

Numerous methods for the isolation of hemicellulose compounds from wood are known. Traditionally hemicelluloses has been extracted from wood with alkali, whereby pentoses, such as xylane and hexoses, such as glucomannan, have been dissolved with sodium or potassium hydroxide from which they can be precipitated. During alkaline extraction, polysaccharides are easily degraded and the wood material is decomposed.

There are also known method in which compounds which dissolve from wood are separated by means of hot water (hot-water extraction). In this case, pentoses and hexoses are dissolved in water having a temperature of maximally 160 degrees, whereby the pentoses and hexoses can further be degraded to furfural and hydroxymethyl-furfural. Both are toxic substances which may inhibit the cellular activity of micro-organisms used for, e.g., fermenting of ethanol and influence their growth.

A traditional solution for separation of polysaccharides is therefor the so-called steam explosion wherein a raw-material which has been milled or in some other way diminuted to a suitable fineness (screen size 1 to 5 mm) is fed into a reactor wherein the acidity of the material is increased with a mineral acid and in which it is then heated at a pressure of about 10 MPa and a temperature of about 190-206° C. using relatively short residence times after which the pressure is abruptly reduced for disintegrating the raw-material.

For acidification, for example sulphuric acid is used at a concentration of about 0.1 to 0.5 mass-%.

There are similar kinds of problems related to steam explosion as to the afore-mentioned hot-water extraction, in particular formation of toxic compounds. The use of acidic chemicals stands for a considerable additional cost and contributes for their part to an increased corrosion of the pressure-resistant equipment. After steam explosion the fibrous matrix is decomposed and it is thus not suitable for applications wherein its mechanical properties are utilized.

There are also known methods wherein the use of steam and liquid along with acid has been combined for extraction of chips. Thus, Published PCT Application No. WO2007/090926 discloses a method of treating wood chips wherein the chips are first steamed without water, and then heating is continued at 150 to 180° C., in particular at about 170° C. Then a diluted hydrolysate solution is added to the steamed chips and used for extraction and hydrolyzation of the chips. The effluent is recovered and partially recirculated.

Published PCT Application No. WO 00/61276) discloses a thermohydrolytical method in which chips are heating in aqueous phase at max. 185° C. and then sulphuric acid is added and the treatment is continued at 185 to 205° C.

With these multistep solutions it is not possible to reach a sufficiently efficient hydrolysis at controlled conditions.

It is an aim of the present invention to eliminate problems relating to the known technology and to provide an entirely novel kind of solution for separating polysaccharides from biomaterial.

In particular, the invention concerns a novel method by which biomass can be treated such that a desired part of its hemicellulose and other extractives can be extracted without endangering the further use of the fibrous matrix. It is also an aim of the invention to provide a method which can be applied to recovery of hemicelluloses from wood, annual and perennial plans (such as grass-stemmed plants and moss) and peat.

The invention is based on the finding that with pressurized hot water it is possible selectively to separate various compounds and groups of compounds essentially without harming the structure of the biomass and the compounds obtained therefrom or alternatively by controlled splitting of these separated compounds.

It has been found in the invention that water extraction can be effected without preliminary acidification if it is carried out at so high pressure that water is kept in liquid phase throughout the whole extraction. By continuing the reaction until a desired degree of extraction is reached and by then reducing the pressure in a controlled fashion so that the fibrous matrix is not broken up, the hemicellulosic compounds are obtained essentially in the form of oligomers and polymers whereas the fibrous matrix is suitable e.g. for the production of fibrous products after further processing.

The treatment according to the invention can be incorporated into the processing chain of the wood processing industry or energy industry as a part thereof.

The extracted hemicellulose concentrate can be hydrolyzed to monomers and alcohols, and alcohols, such as so-called bioethanol and compounds of its kind, can be produced from the hydrolysate or they can be utilized as chemical products. From the same fibrous raw-material it is therefore possible to produce, for example a raw-material for biofuels and paper or cardboard.

More specifically, the method according to the invention is mainly characterized by what is stated in the characterizing part of claim 1.

Considerable advantages are obtained with the invention. Thus, extraction carried out without any addition of chemicals, merely using extraction with hot water, is a rather simple but efficient way of separating the hemicelluloses without essentially disintegrating them. Since the fibrous structure of the biomass is not broken up, fibrous products of high quality (such as paper or cardboard) can be obtained from it at a reduced chemical consumption. By selection of temperature (and corresponding pressure) it is possible directly to influence which hemicellulosic compounds are dissolved in the extractive solution and how great portion of all hemicelluloses are extracted. No separate chemical treatment is needed because compounds obtained from the side-groups split off from the hemicelluloses have an influence on the pH of the extractive solution and participate in promoting dissolution of the hemicelluloses into the aqueous phase.

By using pressurized hot-water extraction in the pretreatment of the biomass raw-material it is possible to isolate easily and employing a method applicable to large-scale, industrial operation without disintegrating valuable compounds and groups of compounds (eg. galactoglucomannans, xylans, oligomers, polymers, monomers) or without breaking up components left in the solid phase (e.g. sellulose and lignins) before any other further treatment. The compounds can also be split in a controlled manner in the process.

As an example it can be mentioned that based on test results, over 90% by weight of the galactoglucomannans can be extracted by batch extraction from milled spruce sawdust already at 170 to 180° C. using an extraction time of 30 to 60 min.

The obtained hemicellulosic compounds are useful raw-materials for the production of biofuel. As far as this aspect is concerned, the advantages of the method are, indeed, considerable. The annual growth of forests in our country amounts to about 100 Mm³, the use of coniferous fibre wood to about 25 Mm³ and the estimated use potential of forest residues to about 15 Mm3. For example, the hemicelluloses contained in the coniferous fibre wood, converted to ethanol, corresponds to about 5 Mt ethanol which is a considerable part of the annual fuel consumption of present-day gasoline-driven cars. The amount of peat sources which can be taken into use have been estimated at 30,000 TWh, expressed in energy units. The total consumption of energy in for example Finland is annually 400 TWh. The forest industry is using well-developed systems for retrieving raw-materials and versatile production facilities for wood refilling. Similarly, the peat industry has its own distribution and refilling systems and a part of the peat is at present used in the energy production of the forest industry, the flows of materials meeting in the same point. When at least a part of the hemicellose contained in the wood flows is directed to production of bio-based raw-materials and traffic fuels, this creates a considerable portion of energy self-containment and ecologically durable energy solutions

It should be pointed out that a fuel made of coniferous wood, such as bioethanol or other corresponding alcohols, are based on renewable biomass and the carbon dioxide release from it during use corresponds to the amount earlier bound to the biomass, which means that it is carbon dioxide neutral. The harvesting and transporting chain stands for only a few percent of the energy contained in wood.

By using bioethanol it is possible to reduce carbon dioxide emissions by exhaust gases cased by the use of fossil fuels and also of other emissions, and it also makes it possible to reduce the risks associated with oil transport.

After extraction the biomass leaves an unsoluble part, e.g. undissolved wood matrix which can be further refined to cellulose by removing lignin. Extraction of hemicellulose by hot water changes the bonding of the cellulosic fibres to the remaining matrix, and these changes offer opportunities to develop also the production process of cellulose pulp in such a way that it will require less energy and chemicals. In these conditions, the energy of the mainly unsoluble lignin compounds can be utilized either in direct heat production and in the production of electricity or lignin can be used for example as a raw-material for biodiesel by the Fischer-Tropsch process. Similarly, from peat moss and peat hemicelluloses having a lower heat value can be separated to a fraction of their own and the lignocellulose remaining in the solid phase can be employed as a raw-material of different kinds of energy products.

Not only is the extracted hemicelulose suitable as a raw-material for fuels, it can also be utilized in the wood processing industry, in particular in the production of paper and cardboard. It can for example by combined with cellulose raw-material obtained after delignification of the wood matrix, whereby the yield of the raw-material is improved. Since the extraction solution is chemical-free, it can already as such, optionally after dilution or concentration, be pumped e.g. to the pulp treatment of a paper or cardboard machine before feeding onto the paper machine.

The invention will be examined more closely with the aid of a detailed description with reference to the attached drawings.

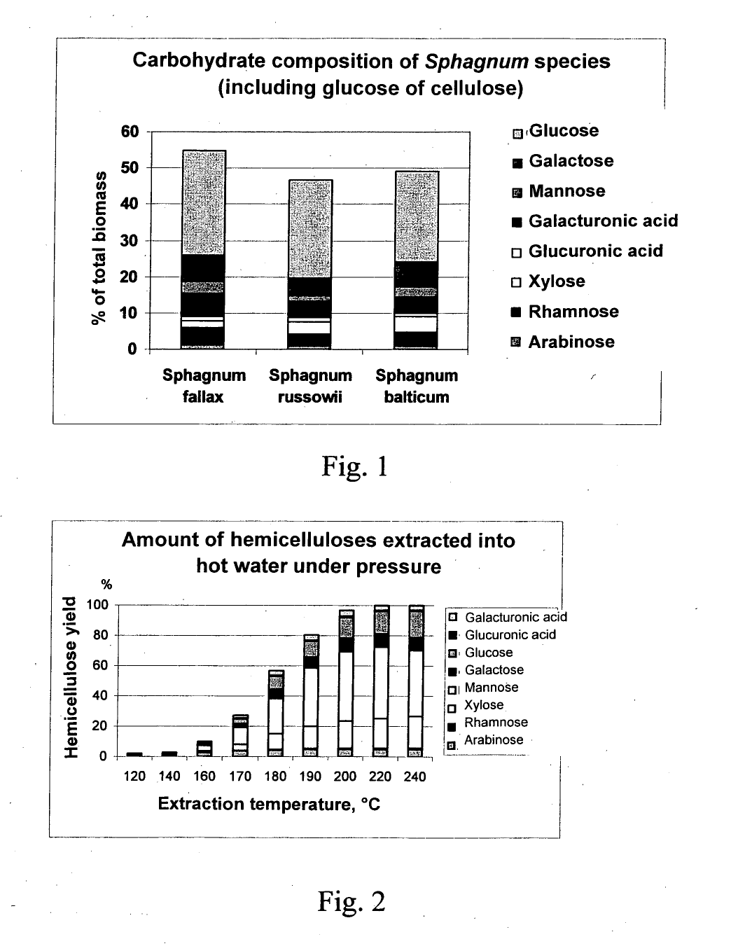

FIG. 1 shows the carbohydrate compositions of various Sphagnum species;

FIG. 2 depicts in the form of a bar chart the influence of extraction conditions on the amount of hemicellulose obtained by extraction from sawdust of spruce on the proportion of extracted sugars in a test carried out by continuous extraction;

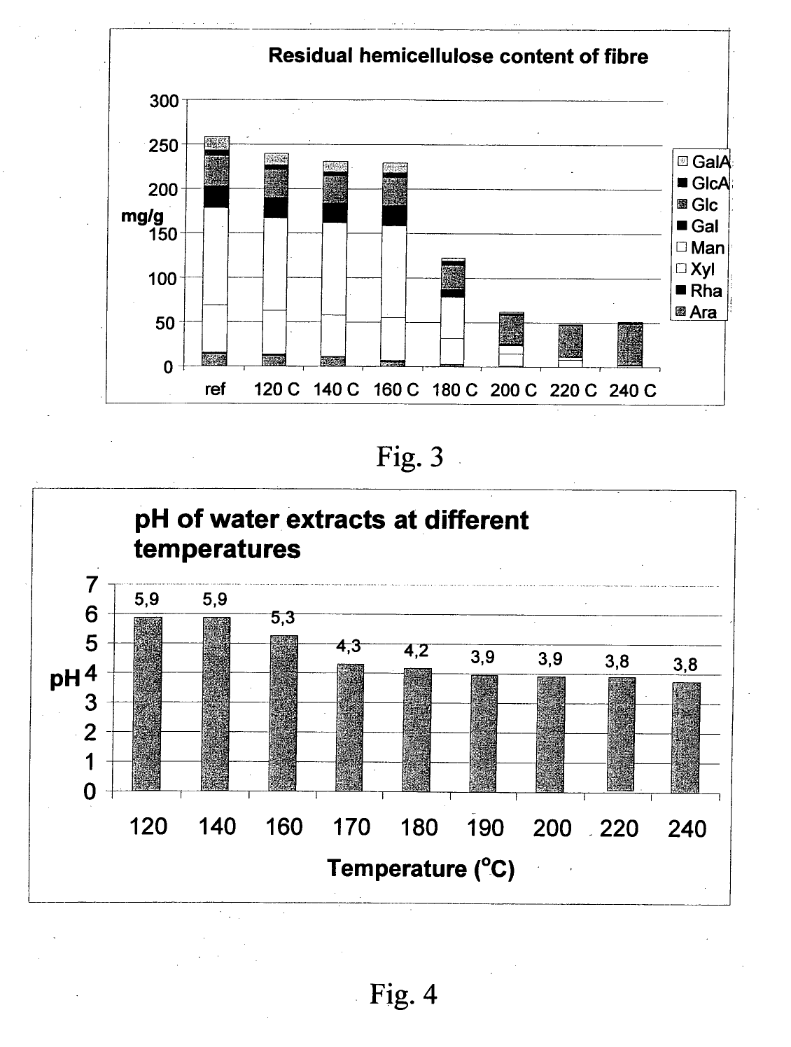

FIG. 3 shows by means of bar charts the residual hemicellulose content of fibrous mass; and

FIG. 4 depicts the pH of extraction solutions as a function of temperature.

In the method according to the invention, sugars (hemicelluloses) and derivatives thereof are separated from biomass, in particular a biomass containing a fibrous matrix by water extraction which is carried out at pressurized conditions at a temperature in excess of 160° C. by degrading the non-extracted fibrous structure as little as possible.

The extractive medium, i.e. water, is kept in the aqueous phase at least essentially during the whole period of extraction, the pressure being maintained in correspondence therewith. In practice, the absolute pressure is at least 1.5 bar (0.15 MPa), typically about 2-100 bar (0.2-10 MPa), in particular about 6-20 bar (0.6-2 MPa.

Since the pressure is maintained during the extraction, the fibrous structure is kept intact and the degradation of the fibrous matrix caused by steam-explosion can be avoided. After the treatment, the pressure is released in a controlled fashion whereby degradation of the fibrous structure of the biomass also can be avoided. In practice, it is possible to go about by lowering the pressure in steps at the same time as the temperature is decreased. According to one embodiment, the pressure is released during about 1-60 minutes, depending on the volume of the extraction vessel. It is essential that during the lowering of the pressure the pressure difference between the ambient and the inner parts of the biomass is maintained so small that the internal pressure is not allowed to decompose the fibrous matrix when it is released. The suitable pressure difference is determined by, e.g. the treatment pressure and the structure/porosity of the biomass and the gas permeability thereof. Generally, it is an aim to reduce pressure such that the pressure difference is at the most 50%, in particular about 20%, preferably at the most 10% of the treatment pressure.

It has been found that by using pressurized hot-water extraction almost all of the hemicellulose contained in wood material and other vegetable materials can be isolated. By regulting the extraction conditions it is possible to control the amount and qualities of the isolated substance.

Total extraction of the hemicellulose can be reached at treatment temperatures which do not significantly differ from the temperatures at present used in, for example, the processes of the pulp and paper industry. Thus, the extraction temperature is preferably at least about 160° C., for example about 165-240° C., in particular about 170-240° C. and advantageously even 190-240° C., and the corresponding absolute pressure about 6-20 bar (0.6-2 MPa). Total extraction designates a situation in which the amount of the separated hemicelluloses is at least 80 weight-%, in particular at least 90 weight-%, of all hemicelluloses of the biomass. A temperature range of 190-240° C. is particularly suitable for wood-based raw-materials.

According to one embodiment, extraction is carried out at conditions where there is as little oxygen as possible present in order to reduce hydrolysis of the hemicellulose. Typically oxygen concentration in liquid phase is then below 1% by volume, in particular it is smaller than about 0.1% by volume, preferably less than 0.01% by volume. If necessary, oxygen can be removed from the liquid used for extraction by treatments known per se.

The extraction can be carried out either batch-wise or continuously. It is also possible to perform the extraction as a semicontinuous process by using an overflow vessel.

In batch extraction biomass and water are fed into a reactor which is closed and pressurized. Heating is then continued for about 1 min to 10 hours, in particular about 5 to 240 minutes, typically about 5 to 180 minutes. Biomass kept at ambient temperature can be contacted with cold water, whereby a slurry having a suitable consistency is first formed from the biomass and the water before the hot-water extraction. It is also possible to bring the water to the extraction in heated form, by arranging for pressurized feed of the water; it can even be introduced at the temperature of the extraction. This will aid in the processing. Generally it is not preferred to significantly to increase the temperature of the biomass in air before the extraction in order to prevent degradation (pilaantumisen/combustion) thereof.

The reaction vessel can be formed by a conventional pressure reactor which is dimensioned to withstand a pressure of, e.g. 30 bar (3 MPa). It is also possible to use a cylinder into which the material is fed, and into preheated water then is pumped and wherein the volume of the which is compressed with a piston to compress the filling volume in order increase the pressure.

The amount of water is typically about 1- to 1000-times greater than the dry weight of the biomass; in particular, water is used in an about 5- to 100-times greater amount. The water used can be purified water, process water of a plant, condensation water or conventional lake water or ground water.

Continuous extraction is carried out with a through-flow reactor, in which the residence time is set to correspond with the desired separation level. Generally the times mentioned for batch processing are suitable, but the residence time can be less than 60 minutes. The biomass is fed into the flow-through reactor preferably as a slurry, mixed in water or water can be separately fed. According to one embodiment, hot water is fed under pressure to the flow-through reactor and it is contacted with the mass or suspension which is maintained at ambient temperature.

The example below shows that at mild conditions, i.e. at a temperature of at least 160 degrees (e.g. at about 160-180° C.), 10 to 20% by weight of the hemicelluloses contained in the mass can be removed. In these conditions, primarily hemicelluloses containing abundantly side groups (arabinoxylanes) are dissolved. By increasing temperature to over 180 degrees (i.e. to about 190 to 220° C.) substantial amounts of all hemicelluloses, also linear, such as glucomannans, can be extracted.

Generally, in the method, by extraction at least about 10% by weight, in particular about 30 to 95% by weight of the hemicelluloses of the fibrous structure are removed.

By suitably selecting the extractive conditions of the process, polymeric structures (e.g. hemicellulose, cellulose) can be further split up to oligomers and monomers.

The pH of the biomass which is subjected to the extractive treatment is not actively change before the extractive treatment or during it. This means that the biomass is, in essence, not separately treated with acid or an acidic substance before the treatment or during it. Thus, no preacidification used in the known art is carried. During the treatment hemicelluloses which are released or extracted and side groups which may split off from them form instead acidic compounds which lower the pH of the biomass during the treatment. It has been found that the pH of the fibrous raw-material which is brought to the extraction, or more specifically the pH of the slurry formed by the fibrous raw-material can be for example about 5.0-8.0, but it is lowered from this value by 1-4 pH unit during the progression of the extraction.

At least two fractions are recovered from extraction, viz. a first fraction containing polysaccharides and a second fraction containing the fibrous structure of the biomass.

According to one embodiment, the fraction can be treated after the extraction with compounds which modify their pH or with other additives. According to another embodiment additives which modify the properties of the mass are incorporated into the mass which is to be treated before the extraction. These additives can be different kinds of auxiliary chemicals which promote extraction and for example enzymes which function as catalysts—in the latter case preferably thermostable enzymes

For a raw-material obtained from spruce wood, pH is typically at the most about 6.0 at the beginning of the extraction and it is lowered to 4.5 when the temperature increases to about 160° C. and past, and it is at the lowest about 3.5-3.8. The change in pH is in particular influenced by acetic acid liberated from the carbohydrates. For pine, the development of the pH value is quite similar. For other biomasses, such as peat, the initial pH value is of, but the decomposition of the hemicelluloses will lower the pH of the aqueous phase even for them.

The aqueous solution obtained from the extraction, containing a first fraction comprising polysaccharides, can be conducted to further processing as such, but it can also be concentrated. For concentration various membrane filtration devices and corresponding separation methods, by which the aqueous phase can be removed without harming the polysaccharides, are particularly suitable.

In one embodiment, hexose and pentose based hemicellulose are separated from each other. In particular, from the extract a significant amount of substantially pure pentoses can be isolated. These can be recovered and used as a separate fraction for further processing.

According to one embodiment, wood is used as a raw-material, the wood being deminuted before treatment or which is available in finely divided form (e.g. as chips or sawdust).

According to another embodiment of the invention, the raw-material used comprises annual plants or parts thereof which optionally are diminuted before treatment.

A third embodiment comprises using peat moss and peat as a raw-material. FIG. 1 shows the carbohydrate compositions of three conventional species of Sphagnum. As will appear from the figure, the mosses contain large amounts of carbohydrates just as other fibrous biomasses. The carbohydrates of peat are particularly easily extractable due to their good solubility and their loose structure which promotes penetration of water.

Peat can be used either isolated and optionally dried and deminuted or both dried and deminuted, or as an aqueous slurry directly obtained from the peat bog. The dry matter content of the peat-water-slurry is preferably about 0.1-95 weight-%, in particular about 1-75 weight-%, preferably about 2-50 weight-%. The peat can suitably be pumped directly from the peat bog to an extractive treatment according to the invention.

The example described in more detail below has been carried out for sawdust obtained from spruce but similar extraction have been effected also with other vegetable species (pine, birch, Sphagnum and canary reed grass) and the result has been quite similar.

The wood-based raw-material is usually used in finely divided form, e.g. as chips, saw-dust or wood flour. The wood-based biomass is therefore in particular formed by softwood or hardwood chips or sawdust.

The more finely divided the raw-material is, the more readily it can be penetrated by water. Generally, the particles of the material have a greatest dimension of about 0.01-100.0 mm in particular about 0.1-50 mm (which corresponds to the dimensions of a typical chip). The dry matter content can vary freely similarly as for peat (0.1-95 weight-%, in particular about 1-75 weight-%, preferably about 2-50 weight-%). Usually there is no need for drying of the raw-material; fresh wood can be used.

After partial or total removal of the polysaccharides, primarily the hemicelluloses, the fibrous material (i.e. the second fraction) is suitable for the preparation of cellulose mass for example by conventional alkaline cooking, such as kraft cooking, or by organosolv cooking. The solution according to the invention is suitable as a pretreatment of, e.g. cellulose cooking.

The method according to the invention can be used for various applications. Thus, in the wood processing industry how-water extraction can be employed as a part of the preparation process of cellulose for improving the quality of the end products and for improving the economy and ecology of the process and potentially also the yield thereof.

The polysaccharide fraction separated from the biomass before cellulose cooking can be recycled to the pulp obtained after the cooking. By adding carbohydrate after cellulose cooking, it is possible to achieve e.g. a better bleaching efficiency and to increase pulp strength.

The extracted hemicellulose fraction can also be used in the preparation of mechanical pulp by adding it to a, e.g. mechanically defibered pulp at a process step after the bleaching thereof in order to regulate the amount of carbohydrates whereby it is possible to improve the yield of the pulp and the strength of a fibrous product (paper or cardboard) produced from the pulp and to increase sterical stability of pitch.

The presented solution facilitates the processing of cellulose as a result of the fact that while hemicellulose is removed between the fibres, the fibrous structure is opened and the cooking process of the cellulose becomes more easy, partly due to improved diffusion of the chemicals and partly due to the removal of a group of substances which consumes cooking chemicals.

The extractive pretreatment reduces the need for chelating chemicals used in bleaching because it removes inorganic metal compounds. Also the amount of calcium which causes fouling of the surfaces is reduced by pressurized hot-water extraction. At the same time, by recycling polysaccharides, yields of the processes can be improved as can the properties of the masses.

In addition to, or instead of, the afore-described modification of a chemical or mechanical pulp, the polysaccharide-based fraction can be used for producing energy or as a raw-material in the chemical industry or in food industry.

Thus, the hexoses of hemicellulose can be further refined to ethanol or used for other purposes. Ethanol can be used as such or as a starting compound for the production of traffic fuels and in the other chemical industry. The pentoses are also potentially useful sources of ethanol in the future, and at present they are important precursors for sweetening agents (xylitol, arabitol etc.).

Extractable compounds (hemicelluloses and other water-soluble compounds) can be utilized also as bioactive compounds in various preparations (probiotics, biofungicides, raffinates).

In the peat industry, extraction will yield from peat hemicellulose having a lower heat value, whereby at the same time the heating and refining value of peat is increased by fermenting the sugars of hemicellulose and partially of cellulose to ethanol. Thus, from peat moss or peat, a polysaccharide fraction can be separated and then heating pellets are produced from the lignocellulosic material formed by the fibrous matrix or it is used as a fuel, e.g. as a raw-material of biodiesel.

By hot-water extraction it is possible to separate aroma and chemical products (cosmetics, aroma products, ursole acid, phenols) and other raw-materials for products of the chemical and pharmaceutical industry from peat.

When using field biomasses, such as straw, it is possible to recover the hemicellulose contained in the biomass and to increase its heat and refining value by fermenting the hemicellulose and also partially the sugars of cellulose to ethanol.

The following non-limiting example illustrates the invention.

### EXAMPLE

Fresh sawdust of sound spruce wood was selected for extration tests. The wood flour was frozen at −20° C. and the samples chosen for the test were freeze-dried to constant weight. Ion exchanged water which had been deaerated ultrasonically was used in the extraction method.

Samples of 200 mg weight were taken of the freeze-dried wood flour and they were placed in an extraction vessel which was put into an oven. The extraction vessel was provided with an inlet for water and an outlet, whereby it was possible continuously to pump water through the sample for achieving continuous extraction. Water was pumped at a flow rate of 1 mL/min and the extraction time was 30 min. The pressure decreased in a controlled fashion when the sample was removed from the extractive vessel. The extracts (about 30 mL) were collected into flasks, and the samples were diluted to a volume of exactly 50 ml. Before this, the pH of the cooled samples were determined Samples were taken from the diluted extracts for the analysis of their composition.

The temperatures varied in the range from 120° C. to 240° C., with 20° C. intervals. Furthermore, the raw-material was extracted at 170° C. and 190° C.

Hemicellulosic carbohydrates were determined from the samples, the oligomeric hemicelluloses being determined after acid methanolysis by silylation and gas chromatography as described by Sundberg et al. (Sundberg A, Sundberg K, Lillandt C, Holmbom B (1996) Determination of hemicelluloses and pectins in wood and pulp fibres by acid methanolysis and gas chromatography. Nord Pulp Pap Res J 11(4):216-219). The residual hemicellulose of the extracted fibrous matrix was determined by the same method. As a reference, an untreated wood sample was used.

Monomeric sugars were determined from samples taken of the extracts, after freeze drying and direct silylation, once again with gas chromatography. Soluble lignin was determined after extraction with MTBE by measuring absorbance at 280 nm using a Shimadzu UV-2401PC (cf. F. Örså, B. Holmbom and J. Thornton, Wood Sci. Technol. 31 (1997) 279. Lignin content of the original, unextracted sample was determined after dissolution in Ac—Br as described by Iiyama et al. (Iiyama, K.; Wallis, A. F. A. An improved acetyl bromide procedure for determining lignin in woods and wood pulps. Wood Sci. Technol. 1988, 22, 271-280).

The pH values were measured before dilution using a Radiometer PHM 200.

Table 1 shows the hemicellulose analysis of a comparative sample:

TABLE 1

| Ara | Rha | Xyl | Man | Gal | Glc | GlcA | GalA | total |
|---|---|---|---|---|---|---|---|---|
| 14 | 2 | 53 | 110 | 24 | 35 | 6 | 15 | 258 |

The hemicellulose concentrations of the extractive solutions at different temperatures are given in Table 2. The amounts are indicated as percentages of the total amount of hemicelluloses. The unit is g/kg.

TABLE 2

| | | | | | | | Glucuronic | Galacturonic | Total |
|---|---|---|---|---|---|---|---|---|---|
| Temperature, ° C. | Arabinose | Rhamnose | Xylose | Mannose | Galactose | Glucose | acid | acid | l |
| 120 | 1.60 | 0.06 | 0.43 | 1.39 | 0.60 | 0.88 | 0.48 | 0.31 | 5.76 |
| 140 | 2.03 | 0.06 | 0.34 | 2.22 | 0.59 | 1.42 | 0.25 | 0.26 | 7.18 |
| 160 | 6.97 | 0.13 | 2.50 | 9.03 | 1.62 | 3.59 | 0.42 | 1.48 | 25.7 |
| 170 | 10.0 | 0.61 | 10.2 | 29.0 | 5.87 | 8.68 | 0.98 | 4.94 | 70.3 |
| 180 | 11.0 | 1.31 | 26.3 | 59.9 | 15.8 | 21.8 | 1.57 | 8.09 | 146 |
| 190 | 12.6 | 1.47 | 37.6 | 99.1 | 18.0 | 27.3 | 1.53 | 9.33 | 207 |
| 200 | 12.4 | 1.96 | 45.9 | 118 | 23.0 | 35.2 | 2.15 | 10.2 | 249 |
| 220 | 12.2 | 2.08 | 50.5 | 121 | 22.3 | 38.7 | 2.03 | 8.22 | 257 |
| 240 | 12.5 | 1.97 | 53.9 | 112 | 22.0 | 44.8 | 1.66 | 7.92 | 257 |

The above indicated results are also graphically depicted in FIG. 2. The figure clearly shows the influence of the extractive conditions on the amount of hemicelluloses extracted from sawdust of spruce, and on the proportion of extracted sugars in a test carried out by continuous extraction. The amount is given in the figure as the portion of the total amount of hemicelluloses (about 250 mg/g spruce sawdust) in the raw-material. A similar yield has been obtained in tests carried out for sawdust of pine.

As will appear from the results, with hot water it is possible from biomass (in this case sawdust) to extract sugars because they dissolve in water and are not decomposed during whereby they can be recovered in the form of oligomers and polymers. These compounds can be used as such or they can be further refined by degrading the molecules to smaller entities.

Based on our tests, typically a maximum of 7% by weight of the total amount of sugars is extracted in the form of monomers when using the method of through-flow-method, the maximum amount however varies depending on temperature and residence time, i.e. depending on extraction time. Extraction times giving yields in excess of 80% correspond to the temperatures used in the production of cellulose.

Correspondingly, the residual amount of hemicellulose in the fibrous mass dropped clearly (cf. FIG. 3). The glucose found at temperatures of 200 to 240 degrees is probably derived from cellulose, because in the derivatization methods used, the cellulose of the extracted matrix is partially made accessible to the analysis method of hemicellulotic sugars.

The Ac—Br lignin of an untreated sample was 28.3%. The lignin concentration of extracts was on the order of a few percents.

FIG. 4 shows the pH values for the extractive solutions as a function of temperature. It can be seen from the figure that the pH value greatly changes when temperature is raised to 160 degrees and above.

1. Method of treating biomass containing a fibrous structure and polysaccharides, comprising:
subjecting the biomass to extractive treatment in which it is heated in aqueous phase at a pressure in excess of 5 bar and at a temperature over 160° C. in order to separate the polysaccharides from the mass;
wherein,
the pH of the biomass subjected to the extractive treatment is not actively lowered during the extractive treatment;
after the treatment the pressure is reduced in a controlled fashion so as significantly not to decompose the fibrous structure of the biomass;
polysaccharides separated from the mass are recovered as a first fraction;
the fibrous structure of the biomass is recovered as a second fraction; and
at least one of these fractions is subjected to further treatment.

2. The method according to claim 1, wherein both fractions are subjected to further treatment separately from each other.

3. The method according to claim 2, wherein the fractions are combined after the further treatment.

4. The method according to claim 1, wherein the polysaccharides are separated essentially in the form of oligomers and polymers.

5. The method according to claim 4, wherein the polysaccharides are hydrolyzed to monomers in order to form a hydrolysate and the obtained hydrolysate is used as a fuel or as a raw-material for the production of chemical products.

6. The method according to claim 1, wherein the fibrous matrix is used for the production of fibrous products after further treatment.

7. The method according to claim 6, wherein the fibrous matrix is used for producing paper or cardboard.

8. The method according to claim 1, wherein the biomass is peat moss or peat.

9. The method according to claim 8, wherein a polysaccharide fraction is separated from the peat moss or peat, and then fuel pellets are produced from the lignocellulosic material formed by the fibrous matrix or is used as a raw-material for fuel, for example biodiesel.

10. The method according to claim 8, wherein the peat moss or peat is extracted for the purpose of separating a fraction containing polysaccharides and other extractable compounds which can be used as a raw-material for products of the chemical or pharmaceutical industry.

11. The method according to claim 1, wherein the biomass is wood-based, in particular chips or sawdust of hardwood or softwood, and a polysaccharide-based fraction is separated and used for producing energy or as a raw-material for the chemical or foodstuff industry.

12. The method according to claim 1, wherein the biomass is wood-based, in particular chips or sawdust of hardwood or softwood, and a polysaccharide-based fraction is separated before cellulose cooking in order to facilitate impregnation of cooking chemicals, in order to reduce consumption of chemicals and energy used in the cooking and in order to improve yield.

13. The method according to claim 12, wherein a polysaccharide-based fraction is separated from the biomass before cellulose cooking and the fraction is recycled to and incorporated into the mass after the cooking.

14. The method according to claim 1, wherein the biomass is wood-based, in particular chips or sawdust of hardwood or softwood, and a polysaccharide-based fraction is separated and combined with mechanical pulp.

15. The method according to claim 13, wherein a polysaccharide-based fraction is separated from the biomass before cellulose cooking in order to prevent decomposition of hemicelluloses.

16. The method according claim 1, wherein water is kept in aqueous phase during the whole extractive treatment in order to prevent decomposition of the fibrous structure.

17. The method according to claim 16, wherein the temperature of the extraction is 160 to 240° C. and the pressure, correspondingly, is 0.5 to 10 MPa.

18. The method according to claim 1, wherein extraction is carried out continuously.

19. The method according to claim 1, wherein extraction is carried out batch-wise.

20. The method according to claim 1, wherein at least about 10% by weight of the hemicelluloses of the fibrous structure are removed by extraction.

21. The method according to claim 1, wherein the pH of the extraction solution is, after the extraction, about 4.5 to 3.5.

22. The method according to claim 1, wherein the pH of the biomass subjected to extractive treatment is not actively lowered before the extractive treatment.

23. The method according to claim 1, wherein fractions obtained after extraction are treated with compounds regulating their pH or with other additives.

24. The method according to claim 1, wherein additives, which modify the properties of the mass, such as adjuvants promoting extraction and e.g. heat-resistant enzymes working as catalysts or combinations thereof, are incorporated into the mass before extraction.
